(19) United States
(12) Patent Application Publication
(10) Pub. No.: US 2002/0077983 A1
(43) Pub. Date: Jun. 20, 2002

(54) Ticket management system, ticket issuance apparatus, ticket input apparatus, its control method, and computer readable storage medium storing programs for realizing functions of such method

(76) Inventor: Nobuhiro Tagashira, Kanagawa (JP)

Correspondence Address: ROBIN BLECKER & DALEY, 2ND FLOOR, 330 MADISON AVENUE, NEW YORK, NY, 10017, US

(21) Appl. No.: 09/999,320

(22) Filed: Oct. 31, 2001

(30) Foreign Application Priority Data
Nov. 2, 2000 (JP) 336450/2000
Oct. 23, 2001 (JP) 325237/2001

(51) Int. Cl. G06F 17/60

(52) U.S. Cl. 705/50

(57) ABSTRACT

In one embodiment, predetermined information is added to an electronic ticket in such a manner that the information can be added to an original paper ticket obtained by outputting the electronic ticket to a paper medium, and cannot be added to a forged paper ticket obtained by copying the original paper ticket. Since the predetermined information can be extracted from the original paper ticket and cannot be extracted from the forged paper ticket, the originality of the paper ticket can be verified depending upon whether the predetermined information can be extracted from the paper ticket. The originality of a paper ticket can be verified at a higher precision by making the extracted predetermined information be authenticated. In another embodiment, predetermined information is added to an electronic ticket by using a key, or predetermined information enciphered by using a key is added to an electronic ticket. The predetermined information can be extracted from a paper ticket by using another key only by a particular user sharing this key. Not only the originality of a paper ticket but also the fairness of the owner of a paper ticket can be verified by judging whether the predetermined information can be extracted from the paper ticket. The originality of a paper ticket and the fairness of an owner can be verified at a higher precision by making the extracted predetermined information be authenticated.

### BACKGROUND OF THE INVENTION

1. Field of the Invention

The present invention relates to a ticket management system for issuing electronic tickets and distributing paper tickets of paper media on which electronic tickets were output, to a ticket issuance apparatus and a ticket input apparatus constituting the ticket management system, to its control method, and to a computer readable storage medium storing programs for realizing the functions of such method.

2. Related Background Art

Various data are processed in the form of electronic data because of the advent of high performance computers and developments in techniques of encoding various data such as still image data, moving image data and audio data.

Services of data communication infrastructures, typically the Internet, are prevailing to present the background of free distribution of electronic data.

Under the above-described technical background, data which has been managed by using paper sheets is also managed in the form of electronic data.

For example, some electronic tickets are being sold via a network although they have been sold at ticket windows and the like. In this system, electronic tickets are issued and paper tickets printed with an ID code and the like of each electronic ticket are distributed. In such a system, as an ID code of an electronic ticket, ASCII codes, bar codes or the like are printed on a paper ticket. This paper ticket can be copied with ease to illegally form a forged ticket. With this system, it is not possible to verify whether a ticket owner is a fair owner. For example, a person who picked up another person's ticket may use it.

### SUMMARY OF THE INVENTION

According to one embodiment of the invention, it is an object to verify whether a paper ticket is an original paper ticket obtained by outputting an electronic ticket to a paper medium.

According to another embodiment of the invention, it is an object to verify whether an owner of a paper ticket is a fair user.

Other objects and features of the present invention will become apparent from the following description taken in conjunction with the accompanying drawings.

### BRIEF DESCRIPTION OF THE DRAWINGS

FIG. 1 is a diagram showing the structure of a ticket management system according to a first embodiment of the invention.

FIG. 2 is a diagram showing the structure of a ticket issuance system of the first embodiment.

FIG. 3 is a diagram showing the structure of a ticket output system of the first embodiment.

FIG. 4 is a diagram showing the structure of a ticket input system of the first embodiment.

FIG. 5 is a flow chart illustrating the operation of the ticket issuance system of the first embodiment.

FIG. 6 is a flow chart illustrating the operation of the ticket output system of the first embodiment.

FIG. 7 is a flow chart illustrating the operation of the ticket input system of the first embodiment.

FIG. 8 is a diagram showing the structure of a ticket issuance system according to a second embodiment of the invention.

FIG. 9 is a diagram showing the structure of a ticket input system of the second embodiment.

FIG. 10 is a flow chart illustrating the operation of the ticket issuance system of the second embodiment.

FIG. 11 is a flow chart illustrating the operation of the ticket input system of the second embodiment.

FIG. 12 is a diagram showing the structure of a ticket issuance system according to a third embodiment of the invention.

FIG. 13 is a diagram showing the structure of a ticket input system of the third embodiment.

FIG. 14 is a flow chart illustrating the operation of the ticket issuance system of the third embodiment.

FIG. 15 is a flow chart illustrating the operation of the ticket input system of the third embodiment.

### DESCRIPTION OF THE PREFERRED EMBODIMENTS

First Embodiment

The first embodiment of the invention will be described.

In a ticket management system of the first embodiment, in order to confirm whether a paper ticket is an original, original confirmation information is added to a paper ticket obtained by outputting an electronic ticket to a paper medium. It is judged whether the original confirmation information can be extracted from a paper ticket.

<Overall Structure and Outline of Ticket Management System>

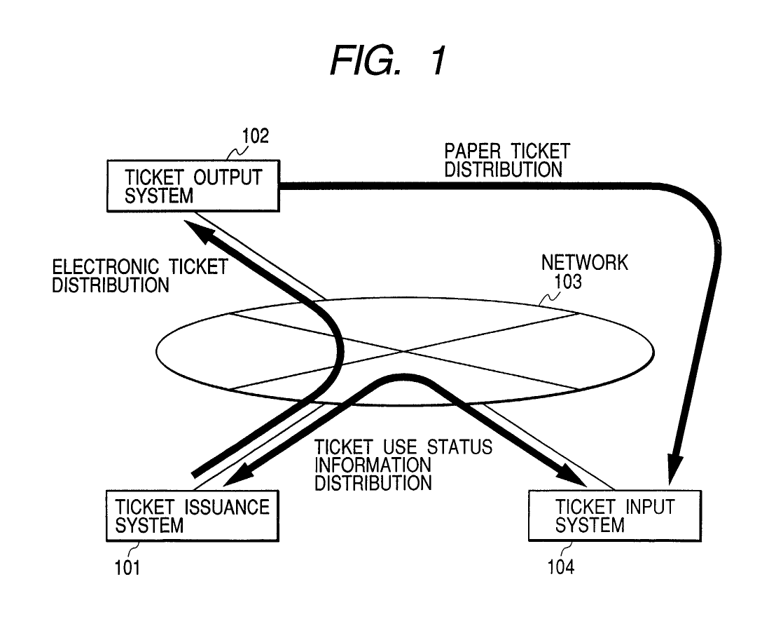

FIG. 1 is a diagram showing the structure of the ticket management system.

The ticket management system of the first embodiment includes one or a plurality of ticket issuance systems 101, a plurality of ticket output systems 102, and one or a plurality of ticket input systems 104. These systems are interconnected by a network 103.

Connection to the network 103 in the embodiment means not only that the systems are always connected to the network 103 via a local area network (LAN), but also that the systems are temporarily connected to the network 103 through dial-up connection or that digital data is transferred via digital data storage media such as a floppy disc (FD), an integrated circuit (IC) card and a memory card.

The outline of the embodiment will be first described with reference to FIG. 1.

A first stage is “electronic ticket distribution”. In this first “electronic ticket distribution” stage, a ticket is issued and distributed to a user.

More specifically, the ticket issuance system 101 issues an electronic ticket added with original confirmation information for verifying the originality of a paper ticket, and distributes the electronic ticket via the network 103 to the ticket output system 102.

A second stage is “paper ticket distribution”. In the second “paper ticket distribution” stage, the ticket is distributed from a ticket user to a ticket verifier.

More specifically, the ticket output system 102 converts the electronic ticket into a paper ticket which is physically distributed to the ticket input system 104.

A third stage is “ticket use status information distribution”. In the third “ticket use status information distribution” stage, the ticket is verified and the ticket use status information is distributed to the ticket issuance system 101. More specifically, the ticket input system 104 verifies the originality of the paper ticket and distributes the ticket use status information to the ticket issuance system 101 via the network 103.

This embodiment has the above-described three distribution stages. Each stage will be detailed in the following.

First, the “electronic ticket distribution” stage will be described.

<Structure of Ticket Issuance System 101>

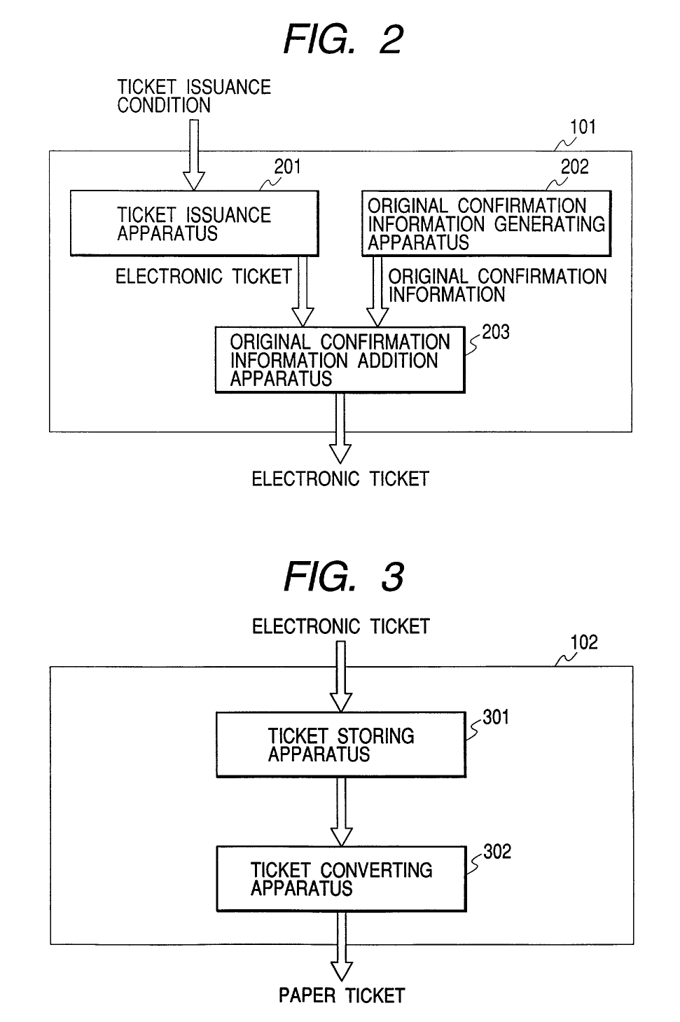

FIG. 2 is a diagram showing the structure of the ticket issuance system 101.

The ticket issuance system 101 of the first embodiment includes a ticket issuance apparatus 201, an original confirmation information generating apparatus 202, and an original confirmation information addition apparatus 203.

The ticket issuance apparatus 201 issues an electronic ticket. An electronic ticket is formed in accordance with the issuance terms (information necessary for the ticket such as ID information of an issuer, issue date and time information, and ticket value information). The issuance terms are not limited only thereto, but other additional information may also be used.

Since an electronic ticket is distributed also in the form of a paper ticket, it contains not only binary data to be used electronically, but also character strings, still image data and the like to be printed on a paper sheet.

The character string data, still image data and the like are not limited only to those data contained in an electronic ticket. For example, similar to the case that in an e-mail system which can transmit only ASCII codes, binary codes are converted into ASCII codes by a command “unencode” or the like when an email with an appended file is transmitted, to thereafter append the ASCII codes to the e-mail, binary data may be converted into ASCII codes or the like when an electronic ticket is converted into a paper ticket to print the character string data, still image data and the like on the paper ticket. In the embodiment, it is assumed that a paper ticket contains still image data.

The original confirmation information generating apparatus 202 generates original confirmation information for confirming the originality of a paper ticket.

For example, the original confirmation information includes a ticket ID for indicating the contents of the ticket, a unique serial code, a mark or a combination thereof. Although not specifically limited, other information or a combination thereof may also be used. Examples of the ticket ID may be a “ticket for movie of . . . ”, a “passenger ticket from A station to B station”, or the like. Examples of the serial code may be a number string or a character string for uniquely discriminating each ticket or a combination thereof. In this embodiment, the originality of a paper ticket is not guaranteed only by using the original confirmation information. Therefore, for example, it is not essential to guarantee the original confirmation information itself by using digital signature techniques.

The original confirmation information addition apparatus 203 receives an electronic ticket and original confirmation information, and adds the original confirmation information to the electronic ticket. In this embodiment, the original confirmation information is added also to a paper ticket printed on a paper medium in accordance with the electronic ticket, and is not added to a forged paper ticket copied from a paper ticket printed on a paper medium by using the electronic paper, by using electronic watermark techniques. The original confirmation information is added to the electronic ticket as electronic water mark data. The original confirmation information not visible to human eyes is added to the paper ticket. A forged paper ticket copied from an original paper ticket with a copier or the like can be judged as not having the original confirmation information because of a degraded image quality.

<Operation of Ticket Issuance System 101>

FIG. 5 is a flow chart illustrating the operation of the ticket issuance system 101 according to the first embodiment. The ticket issuance system 101 is controlled by its main controller (not shown).

Step S501: The ticket issuance apparatus 201 of the ticket issuance system 101 generates an electronic ticket.

Step S502: The original confirmation information generating apparatus 202 of the ticket issuance system 101 generates original confirmation information.

Step S503: The ticket issuance system 101 inputs the electronic ticket and original confirmation information to the original confirmation information addition apparatus 203 to add the original confirmation information to the electronic ticket.

Step S504: The ticket issuance system 101 transmits the electronic ticket added with the original confirmation information to the ticket output system 102 via the network 103.

Next, the “paper ticket distribution” stage will be described.

<Structure of Ticket Output System 102>

FIG. 3 is a diagram showing an example of the structure of the ticket output system 102.

The ticket output system 102 of the first embodiment includes a ticket storing apparatus 301 and a ticket converting apparatus 302.

The ticket storing apparatus 301 receives an electronic ticket and temporarily stores it. The ticket converting apparatus 302 converts the electronic ticket into a paper ticket. For example, the ticket converting apparatus 302 can be realized by an image output apparatus such as an ink jet printer, a laser beam printer and a copier.

<Operation of Ticket Output System 102>

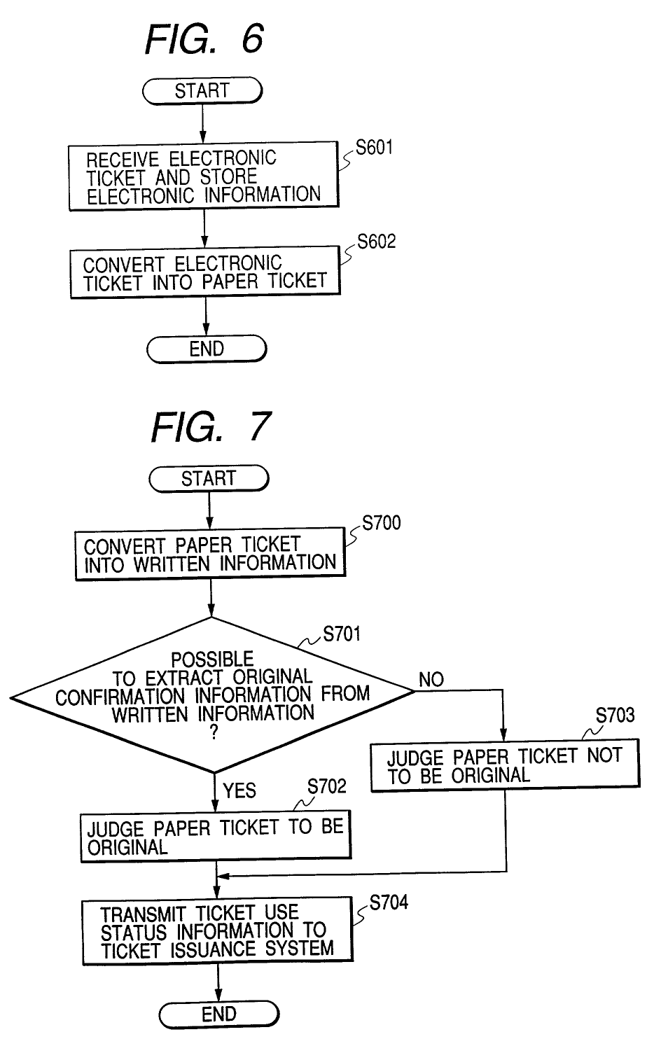

FIG. 6 is a flow chart illustrating the operation of the ticket output system 102 according to the first embodiment. The ticket output system 102 is controlled by its main controller (not shown).

Step S601: The ticket output system 102 receives an electronic ticket and temporarily stores it in the ticket storing apparatus 301.

Step S602: The ticket converting apparatus 302 of the ticket output system 102 converts the electronic ticket into a paper ticket.

Next, the “ticket use status information distribution” stage will be described.

<Structure of Ticket Input System 104>

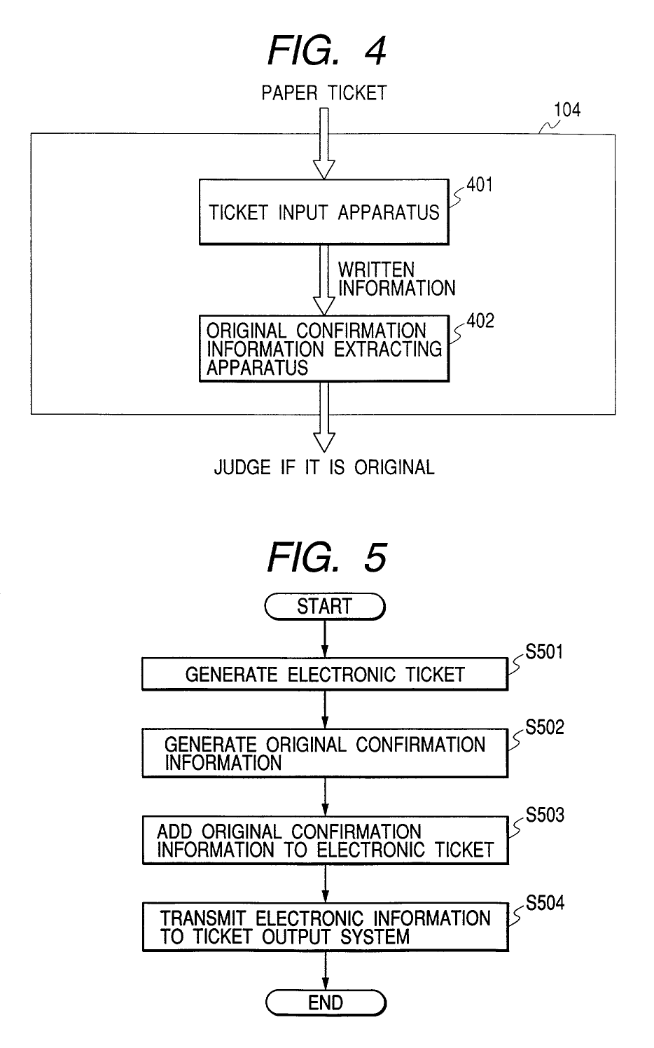

FIG. 4 is a diagram showing the structure of the ticket input system 104.

The ticket input system 104 of the first embodiment includes a ticket input apparatus 401 and an original confirmation information extracting apparatus 402.

The ticket input apparatus 401 converts a paper ticket into electronic information (hereinafter called document information). For example, the ticket input apparatus 401 may be realized by an image input apparatus such as a scanner, a facsimile and a digital camera. The original confirmation information extracting apparatus 402 extracts the original confirmation information from the input document information. A method of extracting the original confirmation information is dependent upon a method of adding the original confirmation information.

<Operation of Ticket Input System 104>

FIG. 7 is a flow chart illustrating the input operation of the ticket input system 104 according to the first embodiment. The ticket input system is controlled by its main controller (not shown).

Step S700: The ticket input apparatus 401 of the ticket input system step 104 converts a paper ticket into document information.

Step S701: The ticket input system 104 inputs the document information to the original confirmation information extracting apparatus 402 to judge whether the original confirmation information can be extracted.

If it is judged at Step S701 that the original confirmation information can be extracted, the flow advances to Step S702, whereas if the original confirmation information cannot be extracted, the flow branches to Step S703.

Step S702: The ticket input system 104 judges that the paper ticket is an original and guarantees the validity of the paper ticket.

Step S703: The ticket input system 104 judges that the paper ticket is not an original and does not guarantee the validity of the paper ticket.

Step S704: If necessary, the ticket input system 104 transmits the ticket use status information such as the originality of a paper ticket to the ticket issuance system 101.

If it is judged at Step S701 that the original confirmation information can be extracted, the extracted original confirmation information may be transmitted to the ticket issuance system 101 to make the ticket issuance system 101 authenticate the original confirmation information and to judge the originality of the paper ticket in accordance with the verification result. The original confirmation information may be authenticated not at the ticket issuance system 101 but at a third party authentication system. The ticket input system 104 may have an authentication apparatus to authenticate the original confirmation information. In these cases, the original confirmation information may contain a URL, an e-mail address or the like for accessing the ticket issuance system 101 or authentication system which authenticates the original confirmation information.

For example, if the ticket input system 104 is installed in a movie theater, a concert hall or the like, when the validity of the paper ticket is guaranteed at Step S702, the gate or door of the entrance may be automatically opened so as to allow the owner of the paper ticket to enter.

<Effects of First Embodiment>

In the first embodiment, the original confirmation information can be extracted from a paper ticket obtained by outputting an original to a paper medium in accordance with the electronic ticket. However, the original confirmation information cannot be extracted from a forged paper ticket obtained by copying an original paper ticket. Therefore, the originality of a paper ticket can be verified by judging whether the original confirmation information can be extracted from the paper ticket. The originality of a paper ticket can be verified at a higher precision by making the extracted original conformation information be authenticated.

Second Embodiment

The second embodiment of the invention will be described.

In the ticket management system of the second embodiment, original confirmation information is added to an electronic ticket by using a key, and it is judged whether the original confirmation information can be extracted from the paper ticket by using a key. Similar to the structure of the ticket management system of the first embodiment, the ticket management system of the second embodiment includes one or a plurality of ticket issuance systems 101, a plurality of ticket output systems 102, and one or a plurality of ticket input systems 104. The structures of the ticket issuance system 101 and ticket input system 104 are different from the first embodiment, as will be described hereinunder.

Similar to the first embodiment, there are three distribution stages including “electronic ticket distribution”, “paper ticket distribution” and “ticket use status information distribution”.

Each distribution stage of the second embodiment will be described.

First, the “electronic ticket distribution” stage will be described.

<Structure of Ticket Issuance System 101>

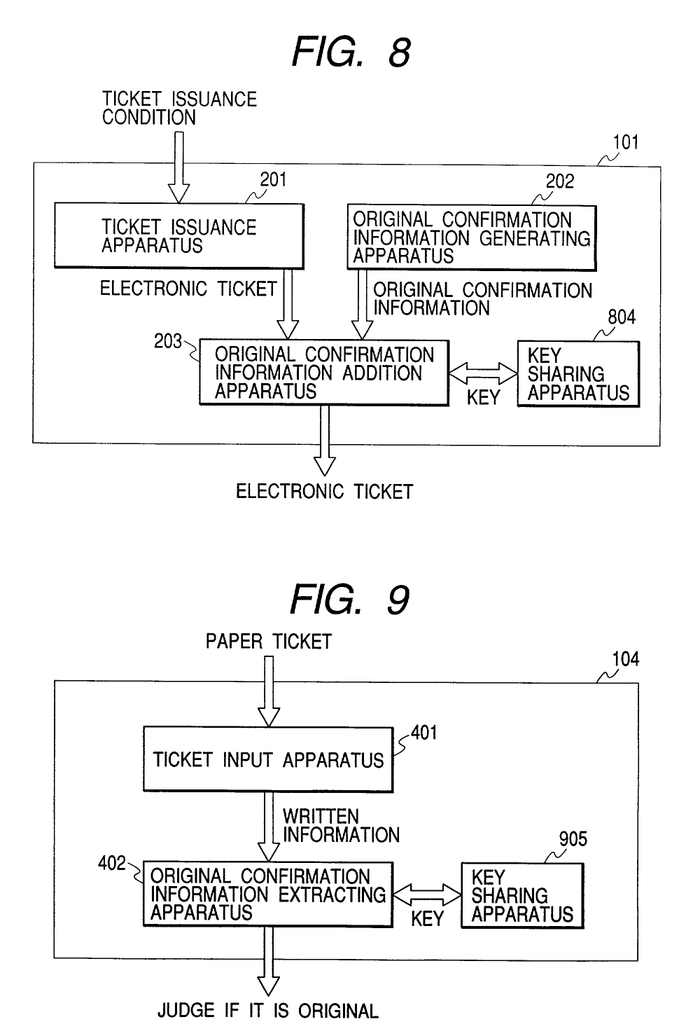

FIG. 8 is a diagram showing the structure of the ticket issuance system 101.

The ticket issuance system 101 of the second embodiment includes a ticket issuance apparatus 201, an original confirmation information generating apparatus 202, an original confirmation information addition apparatus 203, and a key sharing apparatus 804. The ticket issuance apparatus 201 and original confirmation information generating apparatus 202 have similar structures to the first embodiment.

The original confirmation information addition apparatus 203 of the second embodiment receives an electronic ticket, original confirmation information and a key, and adds as electronic watermark data the original confirmation information to the electronic ticket by using the key. The original confirmation information added as the electronic watermark data by using the key cannot be extracted unless another key corresponding to the key is used.

The key is burying/extracting parameters used when the electronic watermark data is added to an electronic ticket.

The key sharing apparatus 804 operates to share the key used for adding original confirmation information and used for extracting the original confirmation information between the ticket issuance system 101 and the ticket input system 104.

More specifically, the key sharing apparatus may be an apparatus for notifying via the network 103 a user of the ticket output system 102 of a key possessed by a key management system (not shown), or an apparatus for notifying via the network 103 a user of the ticket output system 102 of a key automatically generated by the original confirmation information addition apparatus 203. The user of the ticket output system inputs the notified key to the ticket issuance system The shared key may be generated by using cipher techniques.

This embodiment of the invention is not related to a particular key sharing method so that the key sharing method to be used by the ticket issuance system 101 and ticket input system 104 is not specifically limited.

<Operation of Ticket Issuance System 101>

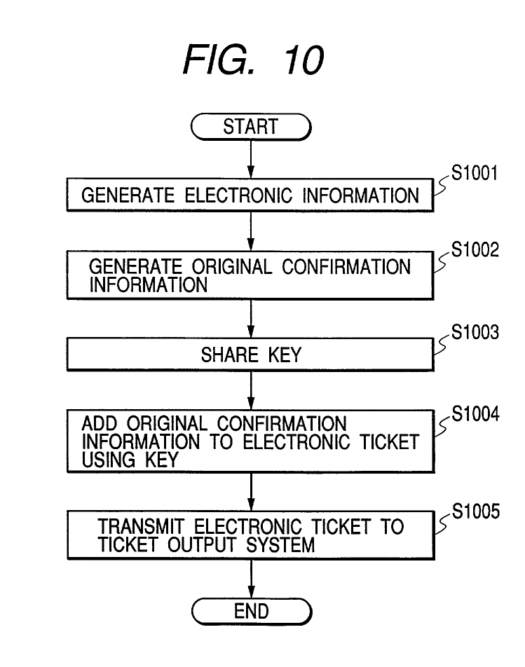

FIG. 10 is a flow chart illustrating the ticket issuance operation of the ticket issuance system 101 according to the second embodiment. The ticket issuance system 101 is controlled by its main controller (not shown).

Step S1001: The ticket issuance apparatus 201 of the ticket issuance system 101 generates an electronic ticket.

Step S1002: The original confirmation information generating apparatus 202 of the ticket issuance system 101 generates original confirmation information.

Step S1003: The ticket issuance system 101 shares the key supplied from the key sharing apparatus 804 with the ticket input system 104.

Step S1004: The ticket issuance system 101 supplies the electronic ticket, original confirmation information and key to the original confirmation information addition apparatus 203 to add the original confirmation information to the electronic ticket by using the key.

Step S1005: The ticket issuance system 101 transmits the electronic key to the ticket output system 102 via the network 103.

The “paper ticket distribution” stage is similar to the first embodiment, and the description thereof is omitted.

<Structure of Ticket Input System 104>

FIG. 9 is a diagram showing the structure of the ticket input system 104.

The ticket input system 104 of the second embodiment includes a ticket input apparatus 401, an original confirmation information extracting apparatus 402, and a key sharing apparatus 905.

The ticket input apparatus 201 is similar to the first embodiment. The key sharing apparatus 905 is used for sharing the key with the key sharing apparatus 804 of the ticket issuance system 101. More specifically, for example, the key notified from the key sharing apparatus 804 upon operation by an owner of the paper ticket is input. The original confirmation information extracting apparatus 402 of the second embodiment extracts the original confirmation information from the document information converted from the paper ticket, by using the key.

<Operation of Ticket Input System 104>

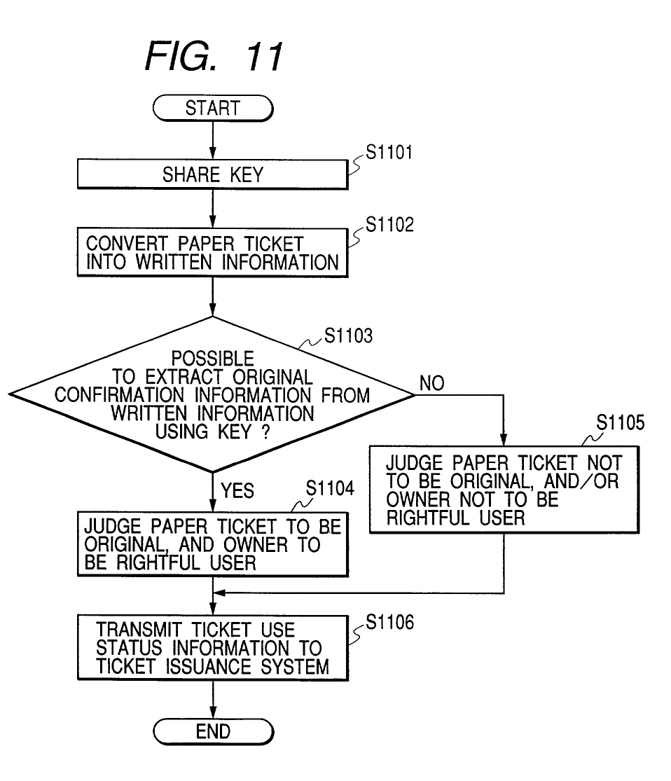

FIG. 11 is a flow chart illustrating the input operation of the ticket input system 104 according to the second embodiment. The ticket input system 104 is controlled by its main controller (not shown).

Step S1101: The ticket input system 104 shares the key supplied from the key sharing apparatus 905. For example, the key is input upon operation by an owner of the paper ticket.

Step S1102: The ticket input apparatus 401 of the ticket input system 104 converts the paper ticket into document information.

Step S1103: The ticket input system 104 judges whether the original confirmation information can be extracted from the document information by using the key.

If it is judged at Step S1103 that the original confirmation information can be extracted, the flow advances to Step S1104, whereas if the original confirmation information cannot be extracted, the flow branches to Step S1105.

Step S1104: The ticket input system 104 judges that the paper ticket is an original and that the owner of the paper ticket is a fair user, and guarantees the validity of the paper ticket.

Step S1105: The ticket input system 104 judges that the paper ticket is not an original and/or that the owner of the paper ticket is not a fair user of the paper ticket, and does not guarantee the validity of the paper ticket.

Step S1106: If necessary, the ticket input system 104 transmits the ticket use status information such as the originality of a paper ticket and the fairness of the owner to the ticket issuance system 101.

If it is judged at Step S1103 that the original confirmation information can be extracted, the extracted original confirmation information may be transmitted to the ticket issuance system 101 to make the ticket issuance system 101 authenticate the original confirmation information and to judge the originality of the paper ticket and the fairness of the owner in accordance with the authentication result. The original confirmation information may be authenticated not at the ticket issuance system 101 but at a third party authentication system. The ticket input system 104 may have an authentication apparatus to authenticate the original confirmation information. In these cases, the original confirmation information may contain a URL, an e-mail address or the like for accessing the ticket issuance system 101 or authentication system which authenticates the original confirmation information.

For example, if the ticket input system 104 is installed in a movie theater, a concert hall or the like, when the validity of the paper ticket is guaranteed at Step S1104, the gate or door of the entrance may be automatically opened so as to allow the owner of the paper ticket to enter.

<Effects of Second Embodiment>

In the second embodiment, the original confirmation information can be extracted from a paper ticket only by a particular user knowing the key. Depending upon whether the owner of a paper ticket can extract the original confirmation information, it is possible to verify whether the owner of the paper ticket is a fair user. The originality of a paper ticket and the fairness of an owner can be verified at a higher precision by making the extracted original confirmation information be authenticated.

Third Embodiment

The third embodiment of the invention will be described.

In the ticket management system of the third embodiment, original confirmation information enciphered by using a key (enciphered original confirmation information) is added to an electronic ticket so that the enciphered original confirmation information can be added to a paper ticket obtained by outputting the electronic ticket to a paper medium. It is then judged whether the enciphered original confirmation information contained in the paper ticket can be deciphered by using a key.

The structure of the ticket management system of the third embodiment is similar to the first embodiment, and the ticket management system includes one or a plurality of ticket issuance systems 101, a plurality of ticket output systems 102, and one or a plurality of ticket input systems 104. The structures of the ticket issuance system 101 and ticket input system 104 are different from the first embodiment, as will be described hereinunder.

Similar to the first embodiment, there are three distribution stages including “electronic ticket distribution”, “paper ticket distribution” and “ticket use status information distribution”.

Each distribution stage of the third embodiment will be described.

First, the “electronic ticket distribution” stage of the third embodiment will be described.

<Structure of Ticket Issuance System 101>

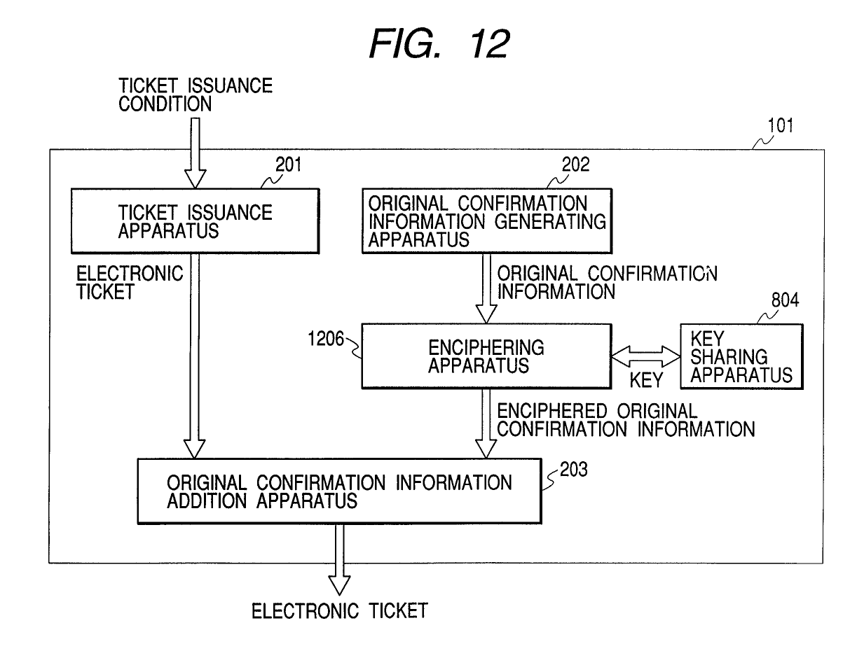

FIG. 12 is a diagram showing the structure of the ticket issuance system 101.

The ticket issuance system 101 of the third embodiment includes a ticket issuance apparatus 201, an original confirmation information generating apparatus 202, an original confirmation information addition apparatus 203, a key sharing apparatus 804, and an enciphering apparatus 1206.

The ticket issuance apparatus 201 and original confirmation information generating apparatus 202 have similar structures to the first embodiment. The key sharing apparatus 804 is similar to the second embodiment. The enciphering apparatus 1206 receives original confirmation information and a key, enciphers the original confirmation information by using the key, and outputs the enciphered original confirmation information. The original confirmation information addition apparatus 203 of the third embodiment receives the enciphered original confirmation information and an electronic ticket, and adds the enciphered original confirmation information to the electronic ticket. The original confirmation information enciphered by using the key cannot be deciphered unless another key corresponding to the key is used.

<Operation of Ticket Issuance System 101>

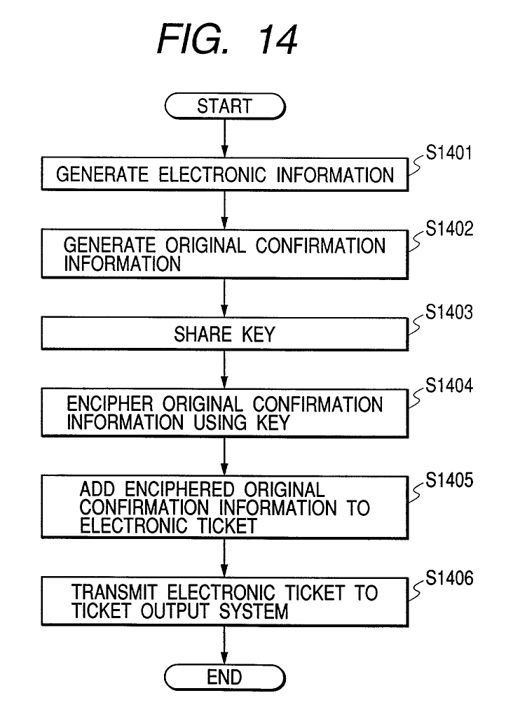

FIG. 14 is a flow chart illustrating the ticket issuance operation of the ticket issuance system 101 according to the third embodiment. The ticket issuance system 101 is controlled by its main controller (not shown).

Step S1401: The ticket issuance apparatus 201 of the ticket issuance system 10′ generates an electronic ticket.

Step S1402: The original confirmation information generating apparatus 202 of the ticket issuance system 101 generates original confirmation information.

Step S1403: The ticket issuance system 101 shares the key supplied from the key sharing apparatus 804.

Step S1404: The ticket issuance system 101 supplies the key and original confirmation information to the enciphering apparatus 1206 to make the apparatus encipher the original confirmation information by using the key and output the enciphered original confirmation information.

Step S1405: The ticket issuance system 101 supplies an electronic ticket and the enciphered original confirmation information to the original confirmation information addition apparatus 203 to make the apparatus add the enciphered original confirmation information to the electronic ticket.

Step 1406: The ticket issuance system 101 transmits the electronic ticket to the ticket output system 102 via the network 103.

The “paper ticket distribution” stage is similar to the first embodiment, and the description thereof is omitted.

Next, the “paper ticket distribution” stage will be described.

<Structure of Ticket Input System 104>

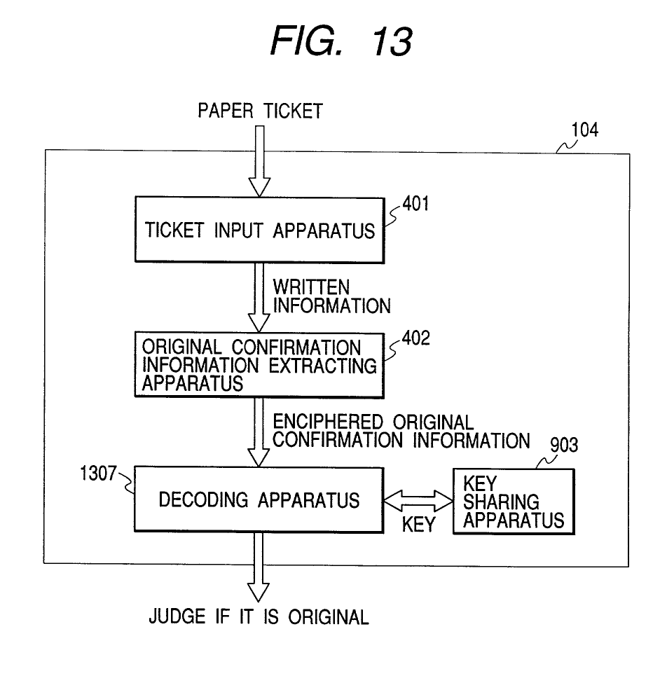

FIG. 13 is a diagram showing the structure of the ticket input system 104.

The ticket input system 104 of the third embodiment includes a ticket input apparatus 401, an original confirmation information extracting apparatus 402, a key sharing apparatus 905, and a deciphering apparatus 1307. The ticket input apparatus 401 and original confirmation information extracting apparatus 402 have the structures similar to the first embodiment. The key sharing apparatus 905 has the structure similar to the second embodiment.

The deciphering apparatus 1307 receives the enciphered original confirmation information and key, deciphers the enciphered original confirmation information by using the key, and outputs the deciphered original confirmation information.

<Operation of Ticket Input System 104>

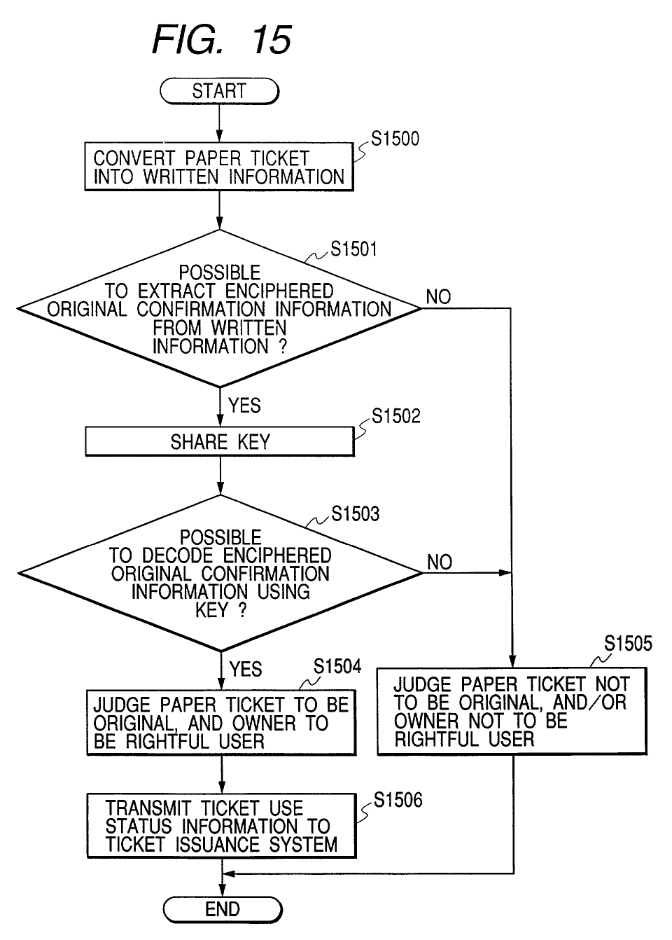

FIG. 15 is a flow chart illustrating the input operation of the ticket input system 104 according to the third embodiment. The ticket input system 104 is controlled by its main controller (not shown).

Step S1500: The ticket input apparatus 401 of the ticket input system 104 converts the paper ticket into document information.

Step S1501: The original confirmation information extracting apparatus 402 of the ticket input system 104 judges whether the enciphered original confirmation information can be extracted from the document information.

If it is judged at Step S1501 that the enciphered original confirmation information can be extracted, the flow advances to Step S1502, whereas if the original confirmation information cannot be extracted, the flow branches to Step S1505.

Step S1502: The ticket input system 104 shares the key supplied from the key sharing apparatus 905.

Step S1503: The ticket input system 104 judges whether the enciphered original confirmation information can be deciphered by using the key.

If it is judged at Step 1503 that the enciphered original confirmation information can be deciphered, the flow advances to Step S1504, whereas if not, the flow branches to Step S1505.

Step S1504: The ticket input system 104 judges that the paper ticket is an original and that the owner of the paper ticket is a fair user, and guarantees the validity of the paper ticket.

Step S1505: The ticket input system 104 judges that the paper ticket is not an original and/or that the owner of the paper ticket is not a fair user of the paper ticket, and does not guarantee the validity of the paper ticket.

Step S1506: If necessary, the ticket input system 104 transmits the ticket use status information such as the originality of a paper ticket and the fairness of the owner to the ticket issuance system 101.

If it is judged at Step S1501 that the original confirmation information can be extracted, the extracted original confirmation information may be transmitted to the ticket issuance system 101 to make the ticket issuance system 101 authenticate the original confirmation information and to judge the originality of the paper ticket and the fairness of the owner in accordance with the authentication result. The original confirmation information may be authenticated not at the ticket issuance system 101 but at a third party authentication system. The ticket input system 104 may have an authentication apparatus to authenticate the original confirmation information. In these cases, the original confirmation information may contain a URL, an e-mail address or the like for accessing the ticket issuance system 102 or authentication system which authenticates the original confirmation information.

For example, if the ticket input system 104 is installed in a movie theater, a concert hall or the like, when the validity of the paper ticket is guaranteed at Step S1504, the gate or door of the entrance may be automatically opened so as to allow the owner of the paper ticket to enter.

<Effects of Third Embodiment>

In the third embodiment, the enciphered original confirmation information contained in a paper ticket can be deciphered only by a particular user knowing the key. Depending upon whether the owner of a paper ticket can decipher the enciphered original confirmation information, it is possible to verify whether the owner of the paper ticket is a fair user. The originality of a paper ticket and the fairness of an owner can be verified at a higher precision by making the deciphered original confirmation information be authenticated.

Other Embodiments

Although a paper ticket obtained by outputting an electronic ticket to a paper medium is used, other tickets obtained by outputting electronic tickets to other media different from paper, such as plastic, cloth and glass may also be used.

The invention is also applicable to a system having a plurality of apparatuses (e.g., a host computer, an interface apparatus, a reader, a printer and the like) or to a single apparatus.

The scope of the invention contains the case wherein software program codes realizing the function of each embodiment described above are supplied to a computer (CPU or MPU) of the apparatus or system connected to various devices realizing the embodiment function, and the computer operates the devices in accordance with the stored programs.

In this case, the software program codes themselves realize the embodiment function. Therefore, the program codes themselves and means for supplying the program codes, e.g., a storage medium storing the program codes, constitute the present invention. The storage medium for storing such program codes may be a floppy disk, a hard disk, an optical disk, a magneto optical disk, a CD-ROM, a magnetic tape, a nonvolatile memory card, a ROM or the like.

It is obvious that the program codes are included in the embodiment of the invention, wherein not only the computer executes the supplied program codes to realize the embodiment function but also the program codes in cooperation with an OS (operating system) running on the computer or with another application or the like realize the embodiment function.

It is obvious that the scope of the invention also contains the case wherein the functions of each embodiment can be realized by writing the program codes into a memory of a function expansion board inserted into a computer or of a function expansion unit connected to the computer, and thereafter by executing a portion or the whole of actual processes by a CPU of the function expansion board or function expansion unit.

What is claimed is:

1. A ticket management system comprising:
a ticket issuance apparatus provided with addition means for adding predetermined information to an electronic ticket; and
a ticket input apparatus provided with judgement means for judging whether the predetermined information can be extracted from an output ticket obtained by printing out the electronic ticket added with the predetermined information by said addition means.

2. A system according to claim 1, further comprising:
authentication means for authenticating the output ticket in accordance with the predetermined information extracted from the output ticket.

3. A system according to claim 1, wherein said addition means adds the predetermined information to the electronic ticket by using electronic watermark techniques.

4. A system according to claim 3, wherein said addition means adds the predetermined information to the electronic ticket in such a manner that the predetermined information is invisibly printed out on the output ticket.

5. A system according to claim 1, wherein:
said addition means adds the predetermined information to the electronic ticket by using a key; and
said judgement means judges whether the predetermined information added by said addition means can be extracted from the output ticket by using a key.

6. A system according to claim 1, wherein:
said addition means adds the predetermined information enciphered by using a key to the electronic ticket; and
said judgement means judges whether the predetermined information enciphered and added by said addition means can be deciphered by using a key and extracted.

7. A system according to claim 1, wherein the predetermined information includes at least one of information on the contents of the electronic ticket, information for unanimously identifying the electronic ticket, information for unanimously identifying an issuer of the electronic ticket, information on an issue date and time of the electronic ticket, and information on a value of the electronic ticket.

8. A ticket issuance apparatus comprising:
addition means for adding predetermined information to an electronic ticket by using electronic watermark techniques; and
output means for outputting the electronic ticket added with the predetermined information by said addition means.

9. An apparatus according to claim 8, wherein said addition means adds the predetermined information to the electronic ticket in such a manner that the predetermined information is invisibly printed out on an output ticket obtained by printing out the electronic ticket.

10. An apparatus according to claim 9, wherein said addition means adds the predetermined information to the electronic ticket in such a manner that the predetermined information can be extracted from an output ticket obtained by printing out the electronic ticket.

11. An apparatus according to claim 9, further comprising:
reception means for receiving the predetermined information extracted from an output ticket obtained by printing out the electronic ticket; and
authentication means for authenticating the output ticket in accordance with the predetermined information received by said reception means.

12. A ticket input apparatus comprising:
input means for inputting an output ticket obtained by printing out an electronic ticket; and
judgement means for judging whether predetermined information can be extracted from the output ticket input by said input means.

13. An apparatus according to claim 12, further comprising transmission means for transmitting the predetermined information extracted from the output ticket to an authentication apparatus for authenticating the output ticket.

14. A method of controlling a ticket issuance apparatus, comprising:
an addition step of adding predetermined information to an electronic ticket by using electronic watermark techniques; and
an output step of outputting the electronic ticket added with the predetermined information by said addition step.

15. A method of controlling a ticket input apparatus, comprising:
an input step of inputting an output ticket obtained by printing out an electronic ticket; and
a judgement step of judging whether predetermined information can be extracted from the output ticket input by said input step.

16. A computer readable storage medium storing a program for performing a method of controlling a ticket issuance apparatus, comprising:
an addition step of adding predetermined information to an electronic ticket by using electronic watermark techniques; and
an output step of outputting the electronic ticket added with the predetermined information by said addition step.

17. A computer readable storage medium storing a program for performing a method of controlling a ticket input apparatus, comprising:
an input step of inputting an output ticket obtained by printing out an electronic ticket; and
a judgement step of judging whether predetermined information can be extracted from the output ticket input by said input step.
